(19) United States
(12) Patent Application Publication
(10) Pub. No.: US 2023/0076596 A1
(43) Pub. Date: Mar. 9, 2023

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 17/983,532

(22) Filed: Nov. 9, 2022

Related U.S. Application Data
(63) Continuation of application No. PCT/JP2020/018804, filed on May 11, 2020.

(51) Int. Cl. H01M 10/0567; H01M 10/052; H01M 10/0569; H01M 4/134

(52) U.S. Cl. CPC H01M 10/0567; H01M 4/134; H01M 10/052; H01M 10/0569; H01M 2004/027; H01M 2300/0028

(57) ABSTRACT

A lithium secondary battery is provided that has high energy density and excellent cycle characteristics. This lithium secondary battery includes: a positive electrode; a separator or a solid electrolyte; a negative electrode that is free of a negative electrode active material; and optionally, an electrolytic solution, wherein charging and discharging are performed by depositing lithium metal on the surface of the negative electrode and electrolytically dissolving the deposited lithium, and the lithium secondary battery includes an additive that inhibits anisotropic crystal growth of the lithium metal by being codeposited with the lithium metal during charging.

### CROSS-REFERENCE TO RELATED APPLICATIONS

This application is a continuation of International Application No. PCT/JP2020/018804, filed May 11, 2020, the entire contents of which are incorporated herein by reference.

### TECHNICAL FIELD

The present invention relates to a lithium secondary battery.

### BACKGROUND ART

In recent years, techniques for converting natural energy such as solar power or wind power into electric energy have attracted more attention. Accordingly, various secondary batteries have been developed as storage devices that are safe and that can store a large amount of electric energy.

Among these, secondary batteries that charge and discharge by transferring metal ions between a positive electrode and a negative electrode are known to have a high voltage and high energy density, and are usually lithium ion secondary batteries. In a typical lithium ion secondary battery, an active material capable of retaining lithium is introduced into the positive electrode and the negative electrode, and charging and discharging are performed by exchanging lithium ions between the positive electrode active material and the negative electrode active material. A lithium metal secondary battery has also been developed that does not use an active material in the negative electrode, but retains lithium by depositing lithium metal on the surface of the negative electrode.

For example, Patent Document 1 discloses a high energy density, high power lithium metal anode secondary battery with a volumetric energy density greater than 1000 Wh/L and/or a mass energy density greater than 350 Wh/kg when discharged at room temperature at a rate of at least 1C. Patent Document 1 discloses that an ultrathin lithium metal anode is used to realize this lithium metal anode secondary battery.

Patent Document 2 discloses a lithium secondary battery containing a positive electrode, a negative electrode, a separation film interposed between the electrodes, and an electrolyte. In the negative electrode of this lithium secondary battery, metal particles are formed on the negative electrode current collector and move from the positive electrode during charging to form lithium metal on the negative electrode current collector in the negative electrode. Patent Document 2 discloses that this lithium secondary battery can solve problems caused by the reactivity of lithium metal and problems that occur during the assembly process, and has improved performance and a longer service life.

### Citation List

### Patent Literature

Patent Document 1: JP 2019-517722 A

Patent Document 2: JP 2019-537226 A

### SUMMARY OF INVENTION

### Technical Problem

When the present inventors studied secondary batteries of the prior art including those described in the patent documents mentioned above, they found that all of them were insufficient in terms of energy density and cycle characteristics.

For example, a typical secondary battery that charges and discharges by transferring metal ions between a positive electrode active material and a negative electrode active material does not have sufficient energy density. Meanwhile, in lithium metal secondary batteries that retain lithium by depositing lithium metal on the surface of a negative electrode, such as those described in the patent documents listed above, dendrites tend to form on the surface of the negative electrode after repeated charging and discharging, which makes short-circuiting and capacity loss more likely to occur. As a result, the cycle characteristics are not sufficient.

A method has also been developed of applying a large amount of physical pressure to a lithium metal secondary battery to keep the interface between a negative electrode and a separator under high pressure and suppress discrete growth during lithium metal precipitation. However, because a large mechanical mechanism is required to apply such a high level of pressure, the weight and volume of the battery increase as a whole, and the energy density decreases.

In view of these problems, it is an object of the present invention to provide a secondary battery having high energy density and excellent cycle characteristics.

### Solution to Problem

One aspect of the present invention is a lithium secondary battery comprising: a positive electrode; a separator; a negative electrode that is free of a negative electrode active material; and an electrolytic solution, wherein charging and discharging are performed by depositing lithium metal on the surface of the negative electrode and electrolytically dissolving the deposited lithium, and the lithium secondary battery includes an additive that inhibits anisotropic crystal growth of the lithium metal by being codeposited with the lithium metal during charging.

Because this lithium secondary battery includes a negative electrode that is free of a negative electrode active material, charging and discharging are performed by depositing lithium metal on the surface of the negative electrode and electrolytically dissolving the deposited lithium metal. As a result, energy density is improved. In a lithium secondary battery containing such an additive, because lithium and the additive are codeposited during charging, lithium metal is deposited on the negative electrode while suppressing anisotropic crystal growth, and formation of dendritic lithium metal that causes deterioration in the cycle characteristics of lithium secondary batteries is suppressed. As a result, the cycle characteristics of the lithium secondary battery are excellent.

The additive may be included in the electrolytic solution or the separator.

The electrolytic solution may contain an ether-based solvent. This aspect of the present invention tends to further suppress the anisotropic growth of lithium metal on the surface of the negative electrode.

The electrolytic solution may contain LiN(SO₂F)₂. This aspect of the present invention tends to further suppress the anisotropic growth of lithium metal on the surface of the negative electrode.

Another aspect of the present invention is a lithium secondary battery comprising: a positive electrode; a solid electrolyte; and a negative electrode that is free of a negative electrode active material, wherein charging and discharging are performed by depositing lithium metal on the surface of the negative electrode and electrolytically dissolving the deposited lithium metal, and the lithium secondary battery includes an additive that inhibits anisotropic crystal growth of the lithium metal by being codeposited with the lithium metal during charging.

Because this lithium secondary battery includes a negative electrode that is free of a negative electrode active material, charging and discharging are performed by depositing lithium metal on the surface of the negative electrode and electrolytically dissolving the deposited lithium. As a result, energy density is improved. In a lithium secondary battery containing such an additive, because lithium and the additive are codeposited during charging, lithium metal is deposited on the negative electrode while suppressing anisotropic crystal growth, and formation of dendritic lithium metal that causes deterioration in the cycle characteristics of lithium secondary batteries is suppressed. As a result, the cycle characteristics of the lithium secondary battery are excellent.

The additive may be included in the solid electrolyte.

Preferably, the amount of elements derived from the additive in a deposited layer which includes lithium metal deposited on the negative electrode in a charged state is 0.001 at% or more and 10 at% or less relative to the entire deposited layer. This aspect of the present invention tends to further suppress the anisotropic growth of lithium metal on the surface of the negative electrode.

The additive is preferably a compound comprising at least one element selected from group 13 elements, group 14 elements, group 15 elements, group 16 elements, alkaline earth metal elements, alkali metal elements, copper, and zinc (excluding lithium, carbon, oxygen, and nitrogen). This aspect of the present invention tends to further suppress the anisotropic growth of lithium metal on the surface of the negative electrode.

Preferably, the compound is at least one selected from the group consisting of chlorides, fluorides, aromatic compounds, and metal complexes. This aspect of the present invention tends to further suppress the anisotropic growth of lithium metal on the surface of the negative electrode.

Preferably, the negative electrode is an electrode consisting of at least one selected from the group consisting of Cu, Ni, Ti, Fe, other metals that do not react with Li, alloys of these metals, and stainless steel (SUS). Because highly flammable lithium metal does not have to be used in this aspect of the present invention during production, safety and productivity are further improved. Also, because the negative electrode is more stable, the cycle characteristics of the secondary battery are further improved.

Preferably, no lithium foil is formed on the surface of the negative electrode in the lithium secondary battery before initial charging. Because highly flammable lithium metal does not have to be used in this aspect of the present invention during production, safety and productivity are further improved.

The positive electrode may include a positive electrode active material.

### Effect of Invention

The present invention can provide a secondary battery having high energy density and excellent cycle characteristics.

### BRIEF DESCRIPTION OF DRAWINGS

FIG. 1 is a schematic cross-sectional view of the secondary battery in the first embodiment of the present invention.

FIG. 2 is a schematic cross-sectional view of the secondary battery in the first embodiment during use.

FIG. 3 is a schematic cross-sectional view of the secondary battery in the second embodiment of the present invention.

### DESCRIPTION OF EMBODIMENTS

Embodiments of the present invention (“embodiments”) will now be described with reference to the drawings when necessary. In the drawings, identical elements are designated by the same reference numbers, and redundant descriptions of these elements has been omitted. Positional relationships such as up, down, left, and right are based on the positional relationship shown in the drawings unless otherwise specified. The dimensional ratios shown in the drawings are not limited to the depicted ratios.

### 1st Embodiment

### Lithium Secondary Battery

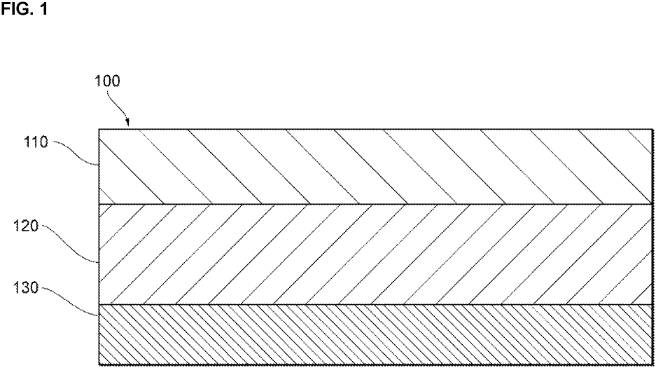

FIG. 1 is a schematic cross-sectional view of the secondary battery in a first embodiment of the present invention. As shown in FIG. 1, the lithium secondary battery 100 in the first embodiment comprises a positive electrode 110, a separator 120, a negative electrode 130 that is free of a negative electrode active material, and an electrolytic solution.

### Negative Electrode

The negative electrode 130 does not contain a negative electrode active material. It is difficult to increase the energy density of a solid-state battery with a negative electrode containing a negative electrode active material due to the presence of the negative electrode active material. Because the lithium secondary battery 100 in the present embodiment has the negative electrode 130 that does not contain a negative electrode active material, such a problem does not occur. In other words, the lithium secondary battery 100 in the present embodiment has a high energy density because metal is deposited on the surface of the negative electrode 130 and charging and discharging are performed by dissolving deposited metal.

In the present specification, “negative electrode active material” refers to a material for holding lithium ions or lithium metal serving as charge carrier (“carrier metal” below) on the negative electrode 130, and may also be referred to as the carrier metal host material. Examples of holding mechanisms include, but are not limited to, intercalation, alloying, and occlusion of metallic clusters.

Examples of negative electrode active materials include, but are not limited to, carbon-based substances, metal oxides, metals, and alloys. Carbon-based substances include, but are not limited to, graphene, graphite, hard carbon, mesoporous carbon, carbon nanotubes, and carbon nanohorns. Examples of metal oxides include, but are not limited to, titanium oxide-based compounds, tin oxide-based compounds, and cobalt oxide-based compounds. There are no particular restrictions on the metal or alloy as long as it can be alloyed with the carrier metal. Examples of the metal or alloy include silicon, germanium, tin, lead, aluminum, gallium, and alloys containing them.

There are no particular restrictions on the negative electrode 130 as long as it does not contain a negative electrode active material and can be used as a current collector. Examples of the negative electrode 130 include at least one selected from the group consisting of metals such as Cu, Ni, Ti, Fe and other metals that do not react with Li, alloys of these metals, and stainless steel (SUS). When SUS is used as the negative electrode 130, any well-known type of SUS can be used. The negative electrode materials mentioned above may be used alone or in combinations of two or more. A “metal that does not react with Li” refers to a metal that does not react with lithium ions or lithium metal to form an alloy under the operating conditions of the secondary battery 100.

The negative electrode 130 is preferably a lithium-free electrode. Because highly flammable lithium metal does not have to be used in the production process, the secondary battery 100 with even better safety and productivity can be realized. From this standpoint and from the standpoint of improving the stability of the negative electrode 130, the negative electrode 130 preferably consists of at least one selected from the group consisting of Cu, Ni, alloys of these metals, and stainless steel (SUS). From the same standpoints, the negative electrode 130 more preferably consists of Cu, Ni, or alloys these metals, and even more preferably of Cu or Ni.

In the present specification, a “negative electrode free of a negative electrode active material” means the amount of the negative electrode active material in the negative electrode is 10% by mass or less relative to the overall mass of the negative electrode. The amount of negative electrode active material in the negative electrode relative to the overall mass of the negative electrode is preferably 5.0% by mass or less, more preferably 1.0% by mass or less, even more preferably 0.1% by mass or less, and still more preferably 0.0% by mass or less. The secondary battery 100 has a negative electrode that is free of a negative electrode active material means that it is an anode-free secondary battery, a zero-anode secondary battery, or an anodeless secondary battery in the general sense of the terms.

The average thickness of the negative electrode 130 is preferably 4 µm or more and 20 µm or less, more preferably 5 µm or more and 18 µm or less, and even more preferably 6 µm or more and 15 µm or less. Because the volume occupied by the negative electrode 130 in the secondary battery 100 is reduced in this aspect of the present invention, the energy density of the secondary battery 100 is further improved.

### Positive Electrode

Positive electrode 110 is not particularly limited as long as it is a positive electrode commonly used in a secondary battery. Positive electrode 110 can be selected depending on the intended use of the lithium secondary battery and the type of carrier metal being used. From the standpoint of increasing the stability and output voltage of the lithium secondary battery 100, the positive electrode 110 preferably contains a positive electrode active material.

The positive electrode active material is a material used to hold carrier metal in the positive electrode, and this serves as a host material for the carrier metal.

Examples of positive electrode active materials include, but are not limited to, metal oxides and metal phosphates. Examples of metal oxides include, but are not limited to, cobalt oxide-based compounds, manganese oxide-based compounds, and nickel oxide-based compounds. Examples of metal phosphates include, but are not limited to, iron phosphate-based compounds and cobalt phosphate-based compounds. Typical examples of positive electrode active materials include LiCoO₂, LiNiₓCo_{y}Mn_{z}O₂ (x + y + z = 1), LiNiₓMn_{y}O₂ (x + y = 1), LiNiO₂, LiMn₂O₄, LiFePO₄, LiCoPO₄, FeF₃, LiFeOF, LiNiOF, and TiS₂. The positive electrode active materials mentioned above can be used alone or in combinations of two or more.

The positive electrode 110 may contain components other than the positive electrode active material. Examples of these components include, but are not limited to, commonly used conductive aids, binders, solid polymer electrolytes, and inorganic solid electrolytes.

Examples of conductive aids that can be used in the positive electrode 110 include, but are not limited to, carbon black, single-wall carbon nanotubes (SW-CNT), multi-wall carbon nanotubes (MW-CNT), carbon nanofibers, and acetylene black. Examples of binders include, but are not limited to, polyvinylidene fluoride, polytetrafluoroethylene, styrene butadiene rubber, acrylic resins, and polyimide resins.

The amount of the positive electrode active material in the positive electrode 110 may be, for example, 50% by mass or more and 100% by mass or less relative to the overall mass of the positive electrode 110. The amount of the conductive aid in the positive electrode 110 may be, for example, 0.5% by mass or more and 30% by mass or less relative to the overall mass of the positive electrode 110. The amount of the binder in the positive electrode 110 may be, for example, 0.5% by mass or more and 30% by mass or less relative to the overall mass of the positive electrode 110. The total amount of the solid polymer electrolyte and the inorganic solid electrolyte may be 0.5% by mass or more and 30% by mass or less relative to the overall mass of the positive electrode 110.

### Separator

The separator 120 is the component that separates the positive electrode 110 and the negative electrode 130 to prevent short circuiting, while maintaining conductivity of the lithium ions serving as the charge carrier between the positive electrode 110 and the negative electrode 130. The separator 120 consists of a material that does not have electronic conductivity and that does not react with lithium ions. The separator 120 also plays a role in retaining the electrolytic solution. There are no particular restrictions on the separator 120 as long as it can play this role. The separator 120 can be composed of, for example, porous polyethylene (PE), polypropylene (PP), or a laminated structure thereof. For example, Erisoto Type P from Teijin Limited can be used as the separator 120.

The separator 120 may be coated with a separator coating layer. The separator coating layer can be applied to one or both sides of the separator 120. The separator coating layer is not particularly limited as long as it has ionic conductivity and does not react with lithium ions. The separator coating layer preferably bonds the separator 120 to the adjacent layer firmly. Examples of such a separator coating layer include, but are not limited to, for example, a layer containing a binder such as polyvinylidene fluoride (PVDF), styrene-butadiene rubber and carboxymethyl cellulose (SBR-CMC) mixtures, polyacrylic acid (PAA), lithium polyacrylate (Li-PAA), polyimide (PI), polyamideimide (PAI), and aramids. The separator coating layer may contain inorganic particles such as silica, alumina, titania, zirconia, magnesium oxide, magnesium hydroxide, or lithium nitrate particles.

The average thickness of the separator 120 is preferably 20 µm or less, more preferably 18 µm or less, and even more preferably 15 µm or less. Because the volume occupied by the separator 120 in the lithium secondary battery 100 is reduced in this aspect of the present invention, the energy density of the lithium secondary battery 100 is further improved. The average thickness of the separator 120 is also preferably 5 µm or more, more preferably 7 µm or more, and even more preferably 10 µm or more. This aspect of the present invention can separate the positive electrode 110 from the negative electrode 130 more reliably, and further suppress short circuiting of the battery.

### Electrolytic Solution

The electrolytic solution (not shown in FIG. 1) plays a role in improving the ionic conductivity of lithium ions that serve as the charge carrier between the positive electrode 110 and the negative electrode 130. The electrolytic solution may be impregnated in the separator 120 or may be sealed together with a laminate of the positive electrode 110, the separator 120, and the negative electrode 130 inside a sealed container. The electrolytic solution contains an electrolyte and a solvent and has ionic conductivity. As a result, the lithium secondary battery 100 has low internal resistance, high energy density, and excellent cycle characteristics.

There are no particular restrictions on the electrolyte that is used. Examples of the electrolyte include, but are not limited to, salts of Li, Na, K, Ca, and Mg. A lithium salt is preferably used as the electrolyte. Examples of lithium salts that can be used include, but are not limited to, Lil, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. From the standpoint of further improving the energy density and cycle characteristics of the lithium secondary battery 100, use of LiN(SO₂F)₂ as the lithium salt is preferred. When LiN(SO₂F)₂ is included as the lithium salt, anisotropic growth of the lithium metal on the negative electrode surface tends to be further suppressed as described later. These lithium salts can be used alone or in combinations of two or more.

There are no particular restrictions on the solvent included in the electrolytic solution. Examples of the solvent include, but are not limited to, ether-based solvents such as fluorinated ethers, and ester-based solvents such as fluorinated ester-based solvents and fluorinated carbonate ester-based solvents. Specific examples of solvents include dimethoxyethane, dimethyl ether, diethylene glycol dimethyl ether, triethylene glycol dimethyl ether, acetonitrile, dimethyl carbonate, diethyl carbonate, ethylmethyl carbonate, ethylene carbonate, propylene carbonate, chloroethylene carbonate, fluoroethylene carbonate, difluoroethylene carbonate, trifluoromethylpropylene carbonate, methyl acetate, ethyl acetate, propyl acetate, methyl propionate, ethyl propionate, nonafluorobutyl methyl ether, nonafluorobutyl ethyl ether, tetrafluoroethyl tetrafluoropropyl ether, 1,1,2,2-terafluoroethyl-2,2,3,3-tetrafluoropropylether, 1,1,2,2-tetrafluoroethyl-2,2,2-trifluoroethylether, methyl-1 ,1,2 ,2-tetrafluoroethylether, ethyl-1,1,2,2-tetrafluoroethylether, trimethyl phosphate, and triethyl phosphate. From the viewpoint of further improving the energy density and cycle characteristics of the lithium secondary battery 100, the solvent is preferably an ether-based solvent. When an ether-based solvent is included as the solvent, as described later, the anisotropic growth of lithium metal on the surface of the negative electrode tends to be further suppressed. These solvents may be used alone or in combinations of two or more.

### Additive (Anisotropic Growth Inhibitor)

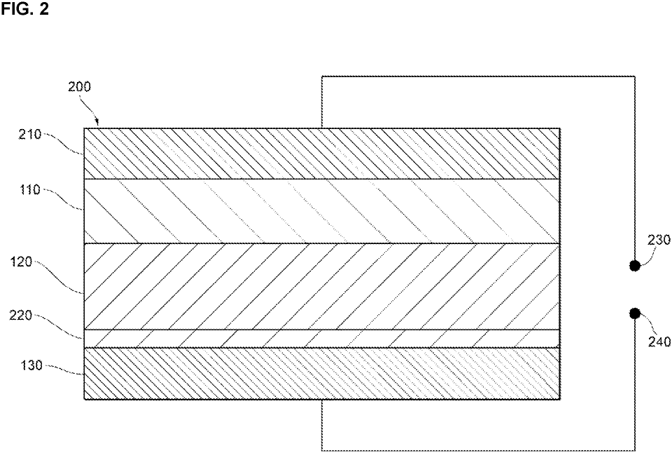

FIG. 2 is a schematic cross-sectional view of the secondary battery in the first embodiment during use. The lithium secondary battery 100 in the first embodiment is configured as a lithium secondary battery 200 in which a positive electrode current collector 210 is connected to the positive electrode 110, and a positive electrode terminal 230 and a negative electrode terminal 240 for connecting to an external circuit are connected to the positive electrode current collector 210 and the negative electrode 130, respectively.

The lithium secondary battery 200 is charged by applying voltage between the positive electrode terminal 230 and the negative electrode terminal 240 so that current flows from the negative electrode terminal 240 to the positive electrode terminal 230 via the external circuit. When the lithium secondary battery 200 is charged, a deposited layer 220 containing lithium metal is deposited on the interface between the negative electrode 130 and the separator 120. When the positive electrode terminal 230 and the negative electrode terminal 240 in the charged lithium secondary battery 200 are connected, the lithium secondary battery 200 is discharged. The discharge proceeds by electrolytic dissolution of the deposited layer 220 deposited at the interface between the negative electrode 130 and the separator 120.

In a lithium secondary battery of the prior art that performs charging and discharging by depositing lithium metal on the surface of the negative electrode and electrolytically dissolving the deposited lithium (“lithium metal secondary battery” below), the lithium metal deposited on the surface of the negative electrode often consists of a simple lithium metal material. As a result of extensive research, the present inventors came to believe that the cycle characteristics of lithium metal secondary batteries of the prior art decline because anisotropic crystal growth of lithium metal is not suppressed on the surface of the negative electrode. That is, it is believed that anisotropic crystal growth of lithium metal is not suppressed on the surface of the negative electrode and lithium metal deposited on the negative electrode surface grows in dendrite form because the lithium metal deposited on the surface of the negative electrode consists of a simple lithium metal material. In addition, it is believed that the capacity of the battery decreases because when a lithium metal secondary battery of the prior art is repeatedly charged and discharged, some of the lithium metal that has grown in the form of dendrites falls off during discharge of the battery, and the amount of lithium metal that is not in electrical contact with the negative electrode, which is inactive during charging and discharging of the battery, increases.

Therefore, the present inventors devised a configuration in which an additive is included that suppresses the anisotropic crystal growth of lithium metal when it is codeposited with lithium metal during charging of the lithium secondary battery (“anisotropic growth inhibitor” below). In other words, in addition to the positive electrode 110, the separator 120, the negative electrode 130 free of a negative electrode active material, and the electrolytic solution, the lithium secondary battery 100 in the first embodiment shown in FIG. 1 includes an additive, and the additive is codeposited with lithium metal during charging of the battery to suppress anisotropic crystal growth of lithium metal. Because this lithium secondary battery 100 contains the anisotropic growth inhibitor, the formation of dendritic lithium metal on the negative electrode surface, which causes deterioration in the cycle characteristics of the lithium secondary battery, is suppressed, and the cycle characteristics are excellent.

In the present specification, “anisotropic crystal growth” means that lithium metal crystal grows only in a specific direction, and the direction of growth can be in any direction. As a result, anisotropically grown lithium metal assumes shapes such as a needle, dendrite, or star shape. “Suppressing anisotropic crystal growth” means keeping lithium metal from growing only in a specific direction, in other words, facilitating isotropic crystal growth of lithium metal. “Isotropic crystal growth” means that lithium metal crystals grow equally in all directions. When lithium metal experiences isotropic crystal growth on the surface of a negative electrode, the shape is plate-like.

In the present specification, “suppressing the formation of dendrites on the surface of a negative electrode” means to suppress the growth of dendrites of lithium metal on the surface of the negative electrode. In other words, it induces non-dendritic growth of lithium metal on the surface of the negative electrode during repeated charging and discharging of the lithium secondary battery. Here, “non-dendritic” includes but is not limited to plate shaped or peak-and-trough shaped growth.

In the lithium secondary battery 100 of the first embodiment shown in FIG. 1, the anisotropic growth inhibitor is included in the electrolytic solution or the separator. From the standpoint of facilitating the anisotropic growth inhibitor to be codeposited with lithium metal during charging of the lithium secondary battery 100, the anisotropic growth inhibitor is preferably dissolved in the solvent. Here, “the electrolytic solution including an anisotropic growth inhibitor” is not limited to the anisotropic growth inhibitor being dissolved in the solvent of the electrolytic solution, but also includes the anisotropic growth inhibitor being precipitated as a solid in the electrolytic solution. Also, “the separator including an anisotropic growth inhibitor” includes the anisotropic growth inhibitor being present in electrolytic solution impregnating the separator, the anisotropic growth inhibitor being present inside the separator as a solid, and the anisotropic growth inhibitor being applied to the surface of the separator as a solid.

There are no particular restrictions on the anisotropic growth inhibitor as long as it can be codeposited with the lithium metal during charging of the secondary battery 100 to suppress anisotropic growth of the lithium metal. Examples of the anisotropic growth inhibitor include, for example, a compound containing at least one element selected from group 13 elements, group 14 elements, group 15 elements, group 16 elements, alkaline earth metal elements, alkali metal elements, copper and zinc (excluding lithium, oxygen, and nitrogen). Group 13 elements refers to boron, aluminum, gallium, and indium; Group 14 elements refers to carbon, silicon, germanium, tin, and lead; Group 15 elements refers to nitrogen, phosphorus, arsenic, antimony, and bismuth; Group 16 elements refers to oxygen, sulfur, selenium, tellurium, and polonium; alkaline earth metal elements refers to beryllium, magnesium, calcium, strontium, and barium; and alkali metal elements refers to lithium, sodium, potassium, rubidium, and cesium.

From the standpoint of further suppressing the anisotropic crystal growth of lithium metal, the anisotropic growth inhibitor is preferably a compound containing at least one element selected from group 13 elements, group 14 elements, group 15 elements, group 16 elements, alkaline earth metal elements, alkali metal elements, copper, and zinc (limited to metal elements or semiconductor elements excluding lithium). From the same standpoint, the anisotropic growth inhibitor is more preferably a compound containing at least one element selected from aluminum, gallium, germanium, tin, lead, antimony, bismuth, selenium, tellurium, magnesium, calcium, strontium, sodium, potassium, rubidium, copper and zinc, more preferably a compound containing at least one element selected from aluminum, tin, antimony, bismuth, selenium, magnesium, potassium, copper, and zinc, and even more preferably a compound containing at least one element selected from aluminum, tin, selenium, potassium, and copper.

When the lithium secondary battery 100 contains the anisotropic growth inhibitor described above and the lithium secondary battery 100 is charged, that is, the potential of the negative electrode becomes positive relative to the positive electrode, the element mentioned above is deposited (co-deposited) on the surface of the negative electrode along with lithium metal. As a result, a co-precipitate of this element or elements and lithium is deposited instead of a simple lithium metal material on the surface of the negative electrode. When a simple lithium metal material is precipitated, anisotropic crystal growth is believed to occur because lithium metal crystals grow in a manner that exposes stable crystal planes. When the element mentioned above is codeposited with the lithium metal, anisotropic crystal growth is believed to be suppressed because a decline in lithium metal crystallinity occurs. Also, when a simple lithium metal material is precipitated, there are believed to be local active sites on the surface where lithium metal is preferentially deposited and anisotropic crystal growth tends to occur. When the element mentioned above is codeposited with the lithium metal, the activity at these active sites is believed to decline and suppress anisotropic crystal growth of lithium metal. However, the suppressive factors are not limited to these.

The anisotropic growth inhibitor may be at least one selected from the group consisting of chlorides, fluorides, bromides, iodides, aromatic compounds, and metal complexes containing the element mentioned above. When the anisotropic growth inhibitor is one of these compounds, the compound tends to be readily available and solubility tends to be better in solvent. From the same standpoint, the anisotropic growth inhibitor is preferably at least one selected from the group consisting of chlorides, fluorides, aromatic compounds, and metal complexes containing the element mentioned above.

There are no particular restrictions on the aromatic compounds. Examples include compounds containing phenyl compounds, tolyl compounds, methoxyphenyl compounds, naphthyl compounds, furanyl compounds, coumarinyl compounds, pyrrolyl compounds, pyridyl compounds, imidazole compounds, pyrazole compounds, thiophenyl compounds, and derivatives thereof. There are no particular restrictions on the metal complexes. Examples include complexes of the elements mentioned above (limited to metal elements) and at least one selected from the group consisting of acetylacetone, trifluoromethane sulfonylimide, acesulfame, trifluoromethanesulfonic acid, ethyl acetoacetate, ethylenediamine, bipyridine, edetic acid, phenanthroline, porphyrin, and crown ether.

Because the lithium secondary battery 100 contains the anisotropic growth inhibitor, the deposited layer 220 containing lithium metal deposited on the negative electrode of the lithium secondary battery 200 shown in FIG. 2 in a charged state contains the element derived from the inhibitors. The deposited layer 220 preferably contains at least one element selected from group 13 elements, group 14 elements, group 15 elements, group 16 elements, alkaline earth metal elements, alkali metal elements, copper, and zinc (except lithium, carbon, oxygen, and nitrogen), more preferably contains at least one element selected from group 13 elements, group 14 elements, group 15 elements, group 16 elements, alkaline earth metal elements, alkali metal elements, copper and zinc (limited to metal elements or semiconductor elements excluding lithium), even more preferably contains at least one element selected from aluminum, gallium, germanium, tin, lead, antimony, bismuth, selenium, tellurium, magnesium, calcium, strontium, sodium, potassium, rubidium, copper, and zinc, still more preferably contains at least one element selected from aluminum, tin, antimony, bismuth, selenium, magnesium, potassium, copper, and zinc, and yet more preferably contains at least one element selected from aluminum, tin, selenium, potassium, and copper. When the deposited layer 220 contains one of these elements, anisotropic crystal growth of lithium metal in the deposited layer 220 is further suppressed.

The amount of the element derived from the anisotropic growth inhibitor in the deposited layer 220 is preferably 0.001 at% or more and 10 at% or less, more preferably 0.005 at% or more and 5 at% or less, and even more preferably 0.010 at% or more and 3 at% or less relative to the entire deposited layer. This aspect of the present invention tends to further suppress the anisotropic growth of lithium metal on the surface of the negative electrode. The amount of element derived from the anisotropic growth inhibitor in the deposited layer 220 can be controlled by adjusting the amount of anisotropic growth inhibitor added, and the amount of element derived from the anisotropic growth inhibitor in the deposited layer 220 can be measured using any method common in the art, such as a method using an inductively coupled plasma mass spectrometer (ICP-MS).

There are no particular restrictions on the amount of anisotropic growth inhibitor, but it is preferably 0.1% by mass or more and 10% by mass or less relative to the entire lithium secondary battery 100. The amount of anisotropic growth inhibitor may be 0.3% by mass or more and 10% by mass or less, or may be 0.5% by mass or more and 10% by mass or less relative to the entire lithium secondary battery 100. When the anisotropic growth inhibitor is present in the electrolytic solution of the lithium secondary battery 100, the amount of anisotropic growth inhibitor is preferably 0.1 % by mass or more and 30% by mass or less, more preferably 0.3% by mass or more and 20% by mass or less, even more preferably 0.5% by mass or more and 15% by mass or less, and still more preferably 1.0% by mass or more and 10% by mass or less relative to the entire electrolytic solution. When the amount of the anisotropic growth inhibitor is within this range, the anisotropic growth of lithium metal on the surface of the negative electrode tends to be further suppressed.

A solid electrolyte interface layer (SEI layer) may be formed on the surface of the negative electrode 130 in FIG. 2. There are no particular restrictions on the SEI layer that is formed, but it may contain, for example, a lithium-containing inorganic compound and a lithium-containing organic compound. The typical average thickness of the SEI layer is 1 nm or more and 10 µm or less. When the SEI layer is formed in the lithium secondary battery 100, the deposited layer 220 may precipitate at the interface between the negative electrode 130 and the SEI layer, and may precipitate at the interface between the SEI layer and the separator 120.

### Secondary Battery Production Method

There are no particular restrictions on the method used to produce the lithium secondary battery 100 shown in FIG. 1 as long as it can produce a lithium secondary battery with the configuration described above. The following method is an example.

The positive electrode 110 may be produced in the following manner. Such a positive electrode active material as mentioned above, a known conductive aid, and a known binder are mixed together to obtain a positive electrode mixture. The mixing ratio may be, for example, 50% by mass or more and 99% by mass or less of the positive electrode active material, 0.5% by mass or more and 30% by mass or less of the conductive aid, and 0.5% by mass or more and 30% by mass or less of the binder relative to the entire mass of the positive electrode mixture. The resulting positive electrode mixture is applied to one side of metal foil (for example, Al foil) with a thickness of, for example, 5 µm or more and 1 mm or less, and then press-molded. The resulting molded material is punched to a predetermined size to obtain a positive electrode 110.

Next, the separator 120 with the configuration described above is prepared. The separator 120 may be produced using any method common in the art, or a commercially available one may be used.

Next, a negative electrode material, such as metal foil (such as electrolytic Cu foil) with a thickness of 1 µm or more and 1 mm or less, is washed with a solvent containing sulfamic acid, punched out to a predetermined size, washed again ultrasonically with ethanol, and then dried to obtain the negative electrode 130.

The positive electrode 110, the separator 120, and the negative electrode 130 described above are laminated in this order to obtain a laminate. The resulting laminate is then sealed in a sealed container together with the electrolytic solution to obtain the lithium secondary battery 100. There are no particular restrictions on the sealed container. Examples of the sealed container include a laminated film.

The anisotropic growth inhibitor may be added to the separator 120, applied to the surface of the separator 120, or added to the electrolytic solution in the step described above. From the standpoint of further suppressing the anisotropic growth of lithium metal on the surface of the negative electrode, the anisotropic growth inhibitor is added to the lithium secondary battery 100 by dissolving it in the electrolytic solution.

### 2nd Embodiment

### Lithium Secondary Battery

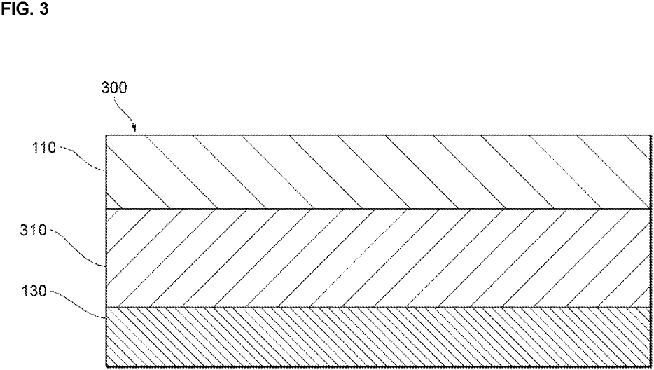

FIG. 3 is a schematic cross-sectional view of the secondary battery in the second embodiment of the present invention. As shown in FIG. 3, the lithium secondary battery 300 in the second embodiment comprises: a positive electrode 110; a solid electrolyte 310; and a negative electrode 130 that is free of a negative electrode active material, wherein charging and discharging are performed by depositing lithium metal on the surface of the negative electrode and electrolytically dissolving the deposited lithium, and the lithium secondary battery includes an additive (an anisotropic growth inhibitor) that inhibits anisotropic crystal growth of the lithium metal by being codeposited with the lithium metal during charging. The configuration and preferred aspects of the positive electrode 110, the negative electrode 130, and the anisotropic growth inhibitor are the same as those of the lithium secondary battery 100 in the first embodiment, except for the points described below. This lithium secondary battery 300 has the same effects as the lithium secondary battery 100 described above.

### Solid Electrolyte

In general, in a battery containing an electrolytic solution, the physical pressure applied by the electrolytic solution to the surface of the negative electrode tends to vary locally due to fluctuations in the liquid. However, because the lithium secondary battery 300 includes the solid electrolyte 310, the pressure applied to the surface of the negative electrode 130 from the solid electrolyte 310 is more uniform, and the shape of the carrier metal deposited on the surface of the negative electrode 130 is more uniform. Because the carrier metal deposited on the surface of the negative electrode 130 in this aspect of the present invention is kept from growing in the form of dendrites, the cycle characteristics of the lithium secondary battery 300 are further improved.

There are no particular restrictions on the solid electrolyte 310 as long as it can be commonly used in lithium solid-state secondary batteries. A material for the solid electrolyte 310 can be selected depending on the intended application of the secondary battery 300 and the type of carrier metal used. Preferably, the solid electrolyte 310 has ionic conductivity and no electron conductivity. When the solid electrolyte 310 has ionic conductivity and no electron conductivity, the internal resistance in the lithium secondary battery 300 is further reduced and short-circuiting inside the lithium secondary battery 300 is further suppressed. As a result, the lithium secondary battery 300 has a higher energy density and capacity and even more excellent cycle characteristics.

There are no particular restrictions on the solid electrolyte 310. Examples of the solid electrolyte 310 include, for example, a solid electrolyte including resins and lithium salts. Examples of the resins include, but are not limited to, resins having an ethylene oxide unit in a main chain and/or a side chain, acrylic resins, vinyl resins, ester resins, nylon resins, polysiloxanes, polyphosphazene, polyvinylidene fluoride, polymethyl methacrylate, polyamides, polyimides, aramids, polylactic acid, polyethylenes, polystyrenes, polyurethanes, polypropylenes, polybutylenes, polyacetals, polysulfones, and polytetrafluoroethylene. These resins can be used alone or in combinations of two or more.

Examples of lithium salts that are included in the solid electrolyte 310 include, but are not limited to, Lil, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. These lithium salts may be used alone or in combinations of two or more.

Generally, the ratio of resin to lithium salt in the solid polymer electrolyte layer is determined by the ratio of oxygen atoms in the resin to lithium atoms in the lithium salt ([Li]/[O]). In the solid electrolyte 310 of the present embodiment, the ratio of resin to lithium salt in terms of the ([Li]/[O]) ratio is preferably 0.02 or more and 0.20 or less, more preferably 0.03 or more and 0.15 or less, and even more preferably 0.04 or more and 0.12 or less.

The solid electrolyte 310 may contain components other than the resins and lithium salts mentioned above. Examples of the components include, but are not limited to, solvents and salts other than lithium salts. Examples of the salts other than lithium salts include, but are not limited to, Li, Na, K, Ca, and Mg salts.

There are no particular restrictions on the solvent. Examples of the solvent include the solvents used in the electrolytic solution of the lithium secondary battery 100 mentioned above.

The average thickness of solid electrolyte 310 is preferably 20 µm or less, more preferably 18 µm or less, and even more preferably 15 µm or less. In this aspect of the present invention, because the volume occupied by the solid electrolyte 310 in the lithium secondary battery 300 is reduced, the energy density of the lithium secondary battery 300 is further improved. The average thickness of solid electrolyte 310 is also preferably 5 µm or more, more preferably 7 µm or more, and even more preferably 10 µm or more. In this aspect of the present invention, the positive electrode 110 and the negative electrode 130 can be separated more reliably, and short circuiting of the battery can be further suppressed.

In the present specification, “solid electrolyte” includes gel electrolytes. Examples of the gel electrolytes include, but are not limited to, those containing polymers, organic solvents, and lithium salts. Examples of the polymers that can be used in the gel electrolyte include, but are not limited to, copolymers of polyethylene and/or polyethylene oxide, polyvinylidene fluoride, and copolymers of polyvinylidene fluoride and hexafluoropropylene.

### Additive (Anisotropic Growth Inhibitor)

In the lithium secondary battery 300 of the second embodiment shown in FIG. 3, the solid electrolyte contains the anisotropic growth inhibitor. Here, “the solid electrolyte containing an anisotropic growth inhibitor” includes the anisotropic growth inhibitor being present in an electrolytic solution impregnating the solid electrolyte, the anisotropic growth inhibitor being present inside the solid electrolyte as a solid, and the anisotropic growth inhibitor being applied to the surface of the solid electrolyte as a solid.

There are no particular restrictions on the amount of anisotropic growth inhibitor used, but it is preferably 0.1% by mass or more and 10% by mass or less relative to the entire lithium secondary battery 300. The amount of anisotropic growth inhibitor may be 0.3% by mass or more and 10% by mass or less, or may be 0.5% by mass or more and 10% by mass or less relative to the entire lithium secondary battery 300. When the anisotropic growth inhibitor is contained in the solid electrolyte of the lithium secondary battery 300, the amount of anisotropic growth inhibitor is preferably 0.1% by mass or more and 30% by mass or less, more preferably 0.3% by mass or more and 20% by mass or less, even more preferably 0.5% by mass or more and 15% by mass or less, and still more preferably 1.0% by mass or more and 10% by mass or less relative to the entire solid electrolyte. When the amount of anisotropic growth inhibitor is within this range, the anisotropic growth of lithium metal on the surface of the negative electrode tends to be further suppressed.

A solid electrolyte interface layer (SEI layer) may be formed on the surface of the negative electrode 130 in FIG. 3. There are no particular restrictions on the SEI layer that is formed, but it may contain, for example, a lithium-containing inorganic compound and a lithium-containing organic compound. The typical average thickness of the SEI layer is 1 nm or more and 10 µm or less. When an SEI layer is formed in the lithium secondary battery 300, the deposited layer may precipitate at the interface between the negative electrode 130 and the SEI layer, and may precipitate at the interface between the SEI layer and the solid electrolyte 310.

### Secondary Battery Production Method

The lithium secondary battery 300 can be produced in the same manner as the method for producing a lithium secondary battery 100 of the first embodiment described above, except that the solid electrolyte is used instead of the separator.

There are no particular restrictions on the method used to produce the solid electrolyte 310, as long as the method produces the solid electrolyte 310 described above. A resin and salt commonly used in a solid electrolyte (such as the resins and lithium salts in the solid electrolyte 310 described above) above are dissolved in an organic solvent. The resulting solution is then cast on a molding substrate to a predetermined thickness to obtain the solid electrolyte 310. Here, the mixing ratio of the resin and the lithium salt may be determined based on the ratio ([Li]/[O]) of the oxygen atoms in the resin and the lithium atoms in the lithium salt, as described above. This ratio ([Li]/[O]) may be, for example, 0.02 or more and 0.20 or less. There are no particular restrictions on the organic solvent that is used, which may be, for example, acetonitrile. There are no particular restrictions on the molding substrate that is used, which may be, for example, a PET film or a glass substrate.

The embodiments described above are provided merely to explain the present invention and are not intended to limit the present invention to the embodiments. Various modifications are possible without departing from the scope and spirit of the present invention.

For example, the lithium secondary battery of the embodiments may be a solid-state lithium secondary battery. Because it is not necessary to use an electrolytic solution in this aspect of the present invention, the problem of electrolytic solution leakage does not occur, and the safety of the battery is further improved.

In the lithium secondary batteries described in the embodiments, there may be no lithium foil to be formed between the separator or the solid electrolyte and the negative electrode prior to the initial charge. When lithium foil is not formed between the separator or solid electrolyte and the negative electrode in the lithium secondary battery of the embodiments prior to the initial charge, highly flammable lithium metal are not used during production, and the lithium secondary battery with better safety and higher productivity is realized.

In the present specification, “the energy density is high” and “high energy density” mean the capacity is high relative to the total volume or total mass of the battery. This is preferably 900 Wh/L or more or 400 Wh/kg or more, and more preferably 1000 Wh/L or more or 430 Wh/kg or more.

In the present specification, “excellent cycle characteristics” means that the rate of decline in battery capacity is low after the number of times of charging and discharging cycles that can be expected during normal use. In other words, when comparing the initial capacity to the capacity after the number of times of charging and discharging cycles that can be expected during normal use, the capacity after the charging and discharging cycles has not declined significantly relative to the initial capacity. Here, “the number of times that can be expected during normal use” can be, for example, 50 times, 100 times, 500 times, 1000 times, 5000 times, or 10,000 times, depending on the application for the lithium secondary battery. The “capacity after the charging and discharging cycles not declining significantly relative to the initial capacity” depends on the application for the lithium secondary battery. For example, it may be 65% or more, 70% or more, 75% or more, 80% or more, 85% or more, or 90% or more of the initial capacity.

### EXAMPLES

The following is a more detailed description of the present invention with reference to examples and comparative examples. The present invention is not limited in any way by these examples.

### Example 1

A mixture of 96 parts by mass LiNi_{0.8}Co_{0.15}Al_{0.05}O₂ positive electrode active material, 2 parts by mass carbon black conductive agent, and 2 parts by mass polyvinylidene fluoride (PVDF) binder was applied to one side of 12 µm-thick Al foil and press molded. The resulting molded object was punched out to obtain a 4.0 cm × 4.0 cm positive electrode.

Next, 8 µm electrolytic Cu foil was washed with a solvent containing sulfamic acid, punched to a size of 4.5 cm × 4.5 cm, washed ultrasonically with ethanol, and then dried to obtain a negative electrode.

A separator whose surface was coated with a mixture of polyvinylidene fluoride (PVDF) and Li(NO₃) was prepared.

4M LiN(SO₂F)₂(LFSl) solution in a mixed solution of dimethoxyethane (DME)/1,1,2,2-tetrafluoroethyl-2,2,3,3-tetrafluoropropyl ether (TTFE)/fluoroethylene carbonate (FEC) (DME:TTFE:FEC = 8:1:1 (volume ratio)) was prepared.

The positive electrode, the separator, and the negative electrode described above were laminated in this order to obtain a laminate. A 100-µm Al terminal and a 100-µm Ni terminal were connected to the positive electrode and the negative electrode by ultrasonic welding, respectively, before inserting the laminate into a laminated outer casing. Next, triphenylantimony was added as an anisotropic growth inhibitor to the electrolytic solution described above in an amount of 5% by mass relative to the overall mass of the entire electrolytic solution, and the solution was injected into the outer casing. The outer casing was then sealed to obtain a lithium secondary battery.

### Example 2

A lithium secondary battery was obtained in the same manner as in Example 1, except that Zn(N(SO₂CF₃)₂)₂ was used as the anisotropic growth inhibitor instead of triphenylantimony.

### Example 3

A lithium secondary battery was obtained in the same manner as in Example 1, except that Zn(SO₃CF₃)₂ was used as the anisotropic growth inhibitor instead of triphenylantimony.

### Example 4

A lithium secondary battery was obtained in the same manner as in Example 1, except that acetylacetonate magnesium (Mg(Acac)₂) was used as the anisotropic growth inhibitor instead of triphenylantimony.

### Example 5

A lithium secondary battery was obtained in the same manner as in Example 1, except that Mg(SO₃CF₃)₂was used as the anisotropic growth inhibitor instead of triphenylantimony.

### Example 6

A lithium secondary battery was obtained in the same manner as in Example 1, except that Mg(N(SO₂CF₃)₂)₂ was used as the anisotropic growth inhibitor instead of triphenylantimony.

### Example 7

A lithium secondary battery was obtained in the same manner as in Example 1, except that bismuth chloride (BiCl₃) was used as the anisotropic growth inhibitor instead of triphenylantimony.

### Example 8

A lithium secondary battery was obtained in the same manner as in Example 1, except that triphenyldifluorobismuth was used as the anisotropic growth inhibitor instead of triphenylantimony.

### Example 9

A lithium secondary battery was obtained in the same manner as in Example 1, except that tetrabutylammonium difluorotriphenylstannate was used as the anisotropic growth inhibitor instead of triphenylantimony.

### Example 10

A lithium secondary battery was obtained in the same manner as in Example 1, except that 6-methyl-1,2,3-oxathiazin-4(3H)-one 2,2-dioxide potassium (acesulfame potassium) was used as the anisotropic growth inhibitor instead of triphenylantimony.

### Example 11

A lithium secondary battery was obtained in the same manner as in Example 1, except that dimethyl selenium was used as the anisotropic growth inhibitor instead of triphenylantimony.

### Example 12

A lithium secondary battery was obtained in the same manner as in Example 1, except that tris(ethylacetoacetate)aluminum (III) was used as the anisotropic growth inhibitor instead of triphenylantimony.

### Example 13

A lithium secondary battery was obtained in the same manner as in Example 1, except that copper (I) trifluoromethanesulfonate/benzene complex was used as the anisotropic growth inhibitor instead of triphenylantimony.

### Comparative Example 1

A lithium secondary battery was obtained in the same manner as in Example 1, except that an anisotropic growth inhibitor was not added.

### Reference Example 1

A lithium secondary battery was obtained in the same manner as in Comparative Example 1, except that 12-µm Cu foil on which 20-µm Li foil was crimped in one side was used as a negative electrode, and the negative electrode and the separator were laminated so that the Li foil on the negative electrode faced the separator.

### Evaluation of Energy Density and Cycle Characteristics

The energy density and cycle characteristics of the lithium secondary batteries produced in the examples and the comparative examples were evaluated as follows.

A lithium secondary battery was charged at 3.5 mA until the voltage reached 4.2 V, and then discharged at 3.5 mA until the voltage reached 3.0 V (the “initial discharge”). Then, a cycle of charging at 7.0 mA until the voltage reached 4.2 V and then discharging at 21 mA until the voltage reached 3.0 V was repeated for 100 cycles at a temperature of 25° C. The ratio of the capacity (“capacity retention rate” below) obtained from the discharge after 100 cycles to the capacity obtained from the initial discharge (the “initial capacity” below) was then determined for the examples and the comparative examples. These ratios are shown in Table 1. The initial capacity of Example 1 was set at 100 for comparative purposes. The initial capacity in Example 1 was 70 mAh.

Table 1

| | Anisotropic Growth Inhibitor | Initial Capacity (-) | Capacity Retention Rate (-) |
|---|---|---|---|
| Example 1 | Triphenylantimony | 100 | 85 |
| Example 2 | Zn(N(SO₂CF₃)₂)₂ | 101 | 86 |
| Example 3 | Zn(SO₃CF₃)₂ | 101 | 82 |
| Example 4 | Mg(Acac)₂ | 102 | 85 |
| Example 5 | Mg(SO₃CF₃)₂ | 102 | 88 |
| Example 6 | Mg(N(SO₂CF₃)₂)₂ | 101 | 87 |
| Example 7 | BiCl₃ | 103 | 86 |
| Example 8 | Triphenylbismuth Difluoride | 100 | 84 |
| Example 9 | Tetrabutylammonium Difluorotriphenyl Stannate | 99 | 93 |
| Example 10 | Acesulfame Potassium | 97 | 94 |
| Example 11 | Dimethylselenide | 98 | 93 |
| Example 12 | Tris(ethylacetoacetato)aluminum (III) | 100 | 93 |
| Example 13 | Copper (I) Trifluoromethanesulfonate/ Benzene Complex | 100 | 94 |
| Comparative Example 1 | | 98 | 40 |
| Reference Example 1 | | 100 | 90 |

It is clear from Table 1 that Examples 1 to 13, which contain an anisotropic growth inhibitor, have a superior initial capacity and capacity retention rate, that is, higher energy density, and superior cycle characteristics compared to Comparative Example 1, which does not contain an anisotropic growth inhibitor. Examples 9 to 13 had a higher capacity retention rate and much better cycle characteristics than Reference Example 1, which used lithium foil on the negative electrode. Because Reference Example 1 had lithium foil on the surface of the negative electrode prior to initial charging, it required highly combustible lithium metal in the production process. As a result, it had inferior safety and productivity, and is not preferred for practical use.

### Industrial Applicability

Because the lithium secondary battery of the present invention has high energy density and excellent cycle characteristics, it has industrial applicability as a power storage device used in various applications.

### Reference Signs List

100, 200, 300: Lithium secondary battery

110: Positive electrode

120: Separator

130: Negative electrode

210: Positive electrode current collector

220: Deposited layer

230: Positive electrode terminal

240: Negative electrode terminal

310: Solid electrolyte

What is claimed is:

1. A lithium secondary battery comprising: a positive electrode; a separator; a negative electrode that is free of a negative electrode active material; and an electrolytic solution,
wherein charging and discharging are performed by depositing lithium metal on the surface of the negative electrode and electrolytically dissolving the deposited lithium, and
the lithium secondary battery comprises an additive that inhibits anisotropic crystal growth of the lithium metal by being codeposited with the lithium metal during charging.

2. The lithium secondary battery according to claim 1, wherein the additive is comprised in the electrolytic solution or the separator.

3. The lithium secondary battery according to claim 1, wherein the electrolytic solution comprises an ether-based solvent.

4. The lithium secondary battery according to claim 1, wherein the electrolytic solution comprises LiN(SO₂F)₂.

5. A lithium secondary battery comprising: a positive electrode; a solid electrolyte; and a negative electrode that is free of a negative electrode active material,
wherein charging and discharging are performed by depositing lithium metal on the surface of the negative electrode and electrolytically dissolving the deposited lithium, and
the lithium secondary battery comprises an additive that inhibits anisotropic crystal growth of the lithium metal by being codeposited with the lithium metal during charging.

6. The lithium secondary battery according to claim 5, wherein the additive is comprised in the solid electrolyte.

7. The lithium secondary battery according to claim 1, wherein the amount of elements derived from the additive in a deposited layer which comprises lithium metal deposited on the negative electrode in a charged state is 0.001 at% or more and 10 at% or less relative to the entire deposited layer.

8. The lithium secondary battery according to claim 1, wherein the additive is a compound comprising at least one element selected from group 13 elements, group 14 elements, group 15 elements, group 16 elements, alkaline earth metal elements, alkali metal elements, copper, and zinc (excluding lithium, carbon, oxygen, and nitrogen).

9. The lithium secondary battery according to claim 8, wherein the compound is at least one selected from the group consisting of chlorides, fluorides, aromatic compounds, and metal complexes.

10. The lithium secondary battery according to claim 1, wherein the negative electrode is an electrode consisting of at least one selected from the group consisting of Cu, Ni, Ti, Fe, other metals that do not react with Li, alloys of these metals, and stainless steel (SUS).

11. The lithium secondary battery according to claim 1, wherein no lithium foil is formed on the surface of the negative electrode before initial charging.

12. The lithium secondary battery according to claim 1, wherein the positive electrode comprises a positive electrode active material.

13. The lithium secondary battery according to claim 5, wherein the amount of elements derived from the additive in a deposited layer which comprises lithium metal deposited on the negative electrode in a charged state is 0.001 at% or more and 10 at% or less relative to the entire deposited layer.

14. The lithium secondary battery according to claim 5, wherein the additive is a compound comprising at least one element selected from group 13 elements, group 14 elements, group 15 elements, group 16 elements, alkaline earth metal elements, alkali metal elements, copper, and zinc (excluding lithium, carbon, oxygen, and nitrogen).

15. The lithium secondary battery according to claim 14, wherein the compound is at least one selected from the group consisting of chlorides, fluorides, aromatic compounds, and metal complexes.

16. The lithium secondary battery according to claim 5, wherein the negative electrode is an electrode consisting of at least one selected from the group consisting of Cu, Ni, Ti, Fe, other metals that do not react with Li, alloys of these metals, and stainless steel (SUS).

17. The lithium secondary battery according to claim 5, wherein no lithium foil is formed on the surface of the negative electrode before initial charging.

18. The lithium secondary battery according to claim 5, wherein the positive electrode comprises a positive electrode active material.
